(19) United States
(12) Patent Application Publication
(10) Pub. No.: US 2013/0074033 A1
(43) Pub. Date: Mar. 21, 2013

(54) DESIGNING A CONFIGURABLE PIPELINED PROCESSOR

(71) Applicants: Ezra D. HALL, Richmond, VT (US); Paul A. NIEKREWICZ, Essex Junction, VT (US); Rohit SHETTY, Essex Junction, VT (US); Aydin SUREN, Essex Junction, VT (US); Sebastian T. VENTRONE, South Burlington, VT (US)

(72) Inventors: Ezra D. HALL, Richmond, VT (US); Paul A. NIEKREWICZ, Essex Junction, VT (US); Rohit SHETTY, Essex Junction, VT (US); Aydin SUREN, Essex Junction, VT (US); Sebastian T. VENTRONE, South Burlington, VT (US)

(73) Assignee: International Business Machines Corporation, Armonk, NY (US)

(21) Appl. No.: 13/234,275

(22) Filed: Sep. 16, 2011

(51) Int. Cl. G06F 3/048; G06F 9/44

(52) U.S. Cl. 717/109; 715/771

(57) ABSTRACT

System and computer-implemented methods herein design a configurable pipelined processor. Such systems and methods provide a configuration specification, by providing a base processor or digital design description, a base instruction set with a plurality of base instructions, and a plurality of configurable features. At least one of the configurable features is an additional instruction different from the base instructions. Further, such systems and methods generate a hardware implementation based on the configuration specification to produce a plurality of configured pipeline stages. The configured pipeline stages are different from base pipeline stages in a base processor or digital design hardware implementation (corresponding to the base processor or digital design description as a result of the additional instruction being included in the configuration specification). Such systems and methods also generate, based on the configuration specification, a plurality of software development tools including an application program compiler.

### BACKGROUND

The embodiments herein relate to designing a configurable pipelined processor, and more specifically to methods and systems that provide a configuration specification, generate a hardware implementation based on the configuration specification, and generate (based on the configuration specification) a plurality of software development tools.

This disclosure relates to how a user estimates a design, and to how the size of the die is estimated. A die sizer uses parameters to factor in a performance/power budget, so that the die size is estimated as accurately as possible. At quote time and netlist time, the chip-level die utilization is calculated assuming a uniform density. As a result, the application specific integrated circuit (ASIC) timing closure effort can be off by as much as 50% of the quoted effort/schedule. The systems and methods disclosed herein provide a more accurate estimation and correlation between quote and netlist estimates of target die utilization to account for application-specific chip-level regularity and non-uniform density.

### SUMMARY

According to one embodiment herein, a computer-implemented method for designing a configurable pipelined process or any digital design maintains a database connected to a wide area network (WAN) such as a cloud-based network. More specifically, this exemplary method maintains base processor, digital design, or digital design descriptions, and associated base instruction sets containing base instructions by extracting the base processor, digital design, or digital design description and the base instructions from pipelined processor designs of a plurality of different users who use the WAN. The method also maintains, in the database, configurable features having additional instructions different from the base instructions by extracting the configurable features and the additional instructions from the pipelined processor or digital designs of the plurality of different users who use the WAN.

The method then receives a configuration specification for the configurable pipelined processor using at least one computerized device. The method receives user selection of a base processor, digital design, or digital design description from the base processor, digital design, or digital design descriptions within the database, user selection of a base instruction set from the base instruction sets within the database, and user selection of at least one configurable feature from the configurable features within the database.

The method generates a hardware implementation for the configurable pipelined processor based on the configuration specification, using the computerized device, to produce a plurality of configured pipeline stages. The configured pipeline stages are different from base pipeline stages in a base processor, digital design, or digital design hardware implementation corresponding to the base processor, digital design, or digital design description as a result of at least one additional instruction associated with the configurable feature being included in the configuration specification. The method also generates, based on the configuration specification, a plurality of software development tools including an application program compiler using the computerized device. The application program compiler is used separately from the configuration specification.

Another disclosed computer-implemented method for designing a configurable pipelined processor also maintains a database connected to a wide area network (WAN) such as a cloud-based network. Again, this exemplary method maintains base processor, digital design descriptions, and associated base instruction sets containing base instructions by extracting the base processor, digital design, or digital design description and the base instructions from pipelined processor designs of a plurality of different users who use the cloud database. The method also maintains, in the database, configurable features having additional instructions different from the base instructions by extracting the configurable features and the additional instructions from the pipelined processor designs of the plurality of different users who use the cloud database.

The method then receives a configuration specification for the configurable pipelined processor using at least one computerized device. To facilitate this, this exemplary method can provide an icon-based graphic display of the base processor, digital design, or digital design descriptions, the base instruction sets, the base instructions, the configurable features, and the additional instructions. The icon-based graphic display can be presented as a floorplan arrangement and the icon-based graphic display permits drag-and-drop placement actions and drag resizing options. The method therefore receives, through the icon-based graphic display, user selection of a base processor, digital design, or digital design description from the base processor, digital design, or digital design descriptions within the database, user selection of a base instruction set from the base instruction sets within the database, and user selection of at least one configurable feature from the configurable features within the database.

The method generates a hardware implementation for the configurable pipelined processor based on the configuration specification, using the computerized device, to produce a plurality of configured pipeline stages. The configured pipeline stages are different from base pipeline stages in a base processor or digital design hardware implementation corresponding to the base processor or digital design description as a result of at least one additional instruction associated with the configurable feature being included in the configuration specification. The method also generates, based on the configuration specification, a plurality of software development tools including an application program compiler using the computerized device. The application program compiler is used separately from the configuration specification.

A computerized system for designing a configurable pipelined processor herein comprises a database connected to a wide area network (WAN). The database maintains base processor, digital design descriptions, and associated base instruction sets containing base instructions. More specifically, the database extracts the base processor, digital design description, and the base instructions from pipelined processor designs of a plurality of different users who use the cloud database. The database further maintains configurable features having additional instructions different from the base instructions by similarly extracting the configurable features and the additional instructions from the pipelined processor designs of the plurality of different users who use the cloud database.

This exemplary system further includes at least one computerized device operatively connected to the database through the cloud database. The computerized device receives a configuration specification for the configurable pipelined processor, when a user selects a base processor or digital design description from the base processor or digital design descriptions within the database, selects a base instruction set from the base instruction sets within the database, and selects at least one configurable feature from the configurable features within the database.

The computerized device generates a hardware implementation for the configurable pipelined processor based on the configuration specification to produce a plurality of configured pipeline stages. Again, the configured pipeline stages are different from base pipeline stages in a base processor or digital design hardware implementation corresponding to the base processor or digital design description as a result of at least one additional instruction associated with the configurable feature being included in the configuration specification. The computerized device generates, based on the configuration specification, a plurality of software development tools including an application program compiler. The application program compiler is used separately from the configuration specification.

A computer-readable storage device embodiment herein comprises a non-volatile computer-readable storage medium storing instructions executable by a computerized device. The instructions cause the computerized device to perform a method for designing a configurable pipelined processor maintains a database connected to a wide area network (WAN) such as a cloud-based network. More specifically, this exemplary method maintains base processor or digital design descriptions and associated base instruction sets containing base instructions by extracting the base processor or digital design description and the base instructions from pipelined processor designs of a plurality of different users who use the cloud database. The method also maintains, in the database, configurable features having additional instructions different from the base instructions by extracting the configurable features and the additional instructions from the pipelined processor designs of the plurality of different users who use the cloud database.

The method then receives a configuration specification for the configurable pipelined processor using at least one computerized device. The method receives user selection of a base processor or digital design description from the base processor or digital design descriptions within the database, user selection of a base instruction set from the base instruction sets within the database, and user selection of at least one configurable feature from the configurable features within the database.

The method generates a hardware implementation for the configurable pipelined processor based on the configuration specification, using the computerized device, to produce a plurality of configured pipeline stages. The configured pipeline stages are different from base pipeline stages in a base processor or digital design hardware implementation corresponding to the base processor or digital design description as a result of at least one additional instruction associated with the configurable feature being included in the configuration specification. The method also generates, based on the configuration specification, a plurality of software development tools including an application program compiler using the computerized device. The application program compiler is used separately from the configuration specification.

### BRIEF DESCRIPTION OF THE DRAWINGS

The embodiments herein will be better understood from the following detailed description with reference to the drawings, which are not necessarily drawing to scale and in which:

FIG. 1 is a schematic diagram illustrating system architecture overview;

FIG. 2 is a schematic diagram illustrating GUI component;

FIG. 3 is a schematic diagram illustrating gate netlist/RTL netlist link;

FIG. 4 is a schematic diagram illustrating RTL to netlist floorplanner;

FIG. 5 is a schematic diagram illustrating gate netlist migration;

FIG. 6 is a flowchart diagram illustrating gate netlist migration;

FIG. 7 is a schematic diagram illustrating Socrates user touch interface program display;

FIG. 8 is a schematic diagram illustrating dialog (written or voice recognition);

FIG. 9 is a schematic diagram illustrating an embodiment herein;

FIG. 10 is a schematic diagram illustrating Socrates program flow;

FIG. 11 is a schematic diagram illustrating architecture creation engine;

FIG. 12 is a schematic diagram illustrating exporting/importing changes;

FIG. 13 is a flow diagram illustrating an embodiment herein;

FIG. 14 is a schematic diagram illustrating an exemplary hardware environment that can be used to implement the embodiments herein;

FIG. 15 is a flow diagram of a design process used in semiconductor design, manufacture, and/or test;

FIG. 16 is a flow diagram of a design process used in semiconductor design, manufacture, and/or test;

FIG. 17 is a flow diagram of a design process used in semiconductor design, manufacture, and/or test;

FIG. 18 is a flow diagram of a design process used in semiconductor design, manufacture, and/or test; and

FIG. 19 is a flow diagram of a design process used in semiconductor design, manufacture, and/or test.

### DETAILED DESCRIPTION

The structures and methods disclosed herein improve the accuracy of the chip-level utilization during timing closure using regularity and non-uniform density. The embodiments herein provide a method to determine the number and nature of the different pipelined stages in a processor design by using an intuitive icon-driven graphic user interface to discover what the user wants to know, what the user wants for inputs and outputs (I/Os), the number and type if I/Os, the memory, the performance targets, the type functions, the bus widths, how many busses, power requirements, and temperature range. The system and methods herein determine unique floorplan arrangements, data flow directions, metal stacks, bus directions, clock domains, voltage domains, and jitter tolerance. The embodiments herein also identify RF circuits, electro-static discharge (ESD) considerations, noise tolerance/high speed I/Os, sleep abilities, type of math units, branch structures, blocked out functions, and determine how the user will perform testing.

The embodiments herein can work with any design planning system, whether currently known or developed in the future. When working with design planning systems, the embodiments herein ask how many pipelines the user would like, determine the type of clock tolerance, ask how fast the user wants the pipelines to be, create a clock tree, and ask if the user has a similar unit, etc.

This disclosure provides systems and methods that help guide the creation of an architecture. This tool leverages conventional die sizing engines and their associated library and intellectual property (IP) information, to create die sizings. The embodiments herein can accurately estimate integrated circuit (IC) size, power, leakage, performance, and cost. These embodiments enable rapid “what-if” analysis across design architecture, IP, and manufacturing process options to optimize design specifications. Further, the disclosed embodiments achieve die size and power reductions through architectural exploration, generate complete IC economic analysis and budgetary quotes, offer a fast, accurate, and easy-to-use environment across engineering, management, and sales and marketing organizations, and accelerate and promote IP reuse through an included intranet-based IP catalog management system.

These embodiments support estimation with internal or custom IP and manufacturing processes, support estimations specific to leading foundry manufacturing processes, enable pre-register transfer level (pre-RTL) power estimation, low-power planning, and critical point filter (CPF) authoring and exploration, and assess performance achievability in specific manufacturing processes with specific IP components. Such embodiments provide tunable estimation models for the utmost in estimation accuracy, and support fully customizable IC economic models including key variables and equations. The programming application programming interfaces (APIs) disclosed herein enable customized technical and economic analysis, integrate with enterprise IP, product lifecycle management (PLM), and computer aided design (CAD) environments, and enable convergence in silicon through direct interface to downstream design and implementation tools.

Conventional processes for chip architecture creation, change, and technology migration leverage people with experience to guide the whiteboard sessions, and use electronic data automation (EDA) tools, to input, analyze, change, and optimize an architecture. This work requires experienced team members, and is highly iterative. Additionally, knowledge sharing/learning is not easily transferred amongst teams, resulting in sub-optimal implementations and excessive duplication of effort.

In view of this, the present disclosure outlines methodologies and systems whereby intelligence is instilled into the architecture manipulation tool set from knowledge extracted from the history created by previous designs (designs of different users who share their previous designs in a cloud-based design database), allowing greater ease of input and optimization of the architecture. These methods/systems include intuitive graphical touch interfaces, intelligence in the form of selection dialogues for rules/statistical/project based recommendations (self learning), and provide integration of the tool suite.

In one example of the system and methodology outlined in this disclosure, the user loads from, for example a local database or a network-based (e.g., cloud-based) database, a prior architecture by reading in Verilog (a hardware description language), other formats, or a prior project (options also exist to start from scratch). The user interface is in the form of a highly interactive graphical user interface, including multi-touch capability such as can do multi-point controls of the information for a more natural human interface with built-in dashboard real time feedback of the changes.

The design planning tool analyses the design, including placement and definition of all macro's, I/O's, memory, and other intellectual property (IP) blocks, and creates, for example, Socrates tool views. The information is based upon the previous design, new incremental design, and places holder functions that allow the user to weight via the graphic user interface (GUI) the overall size and other parameters of the block. The user can add incremental functions from the cloud-based database via the GUI, and connect the inputs/outputs (I/Os) to blocks via finger drags or other means and affect the area by a dashboard control. Upon completion, the design planning tool can, if desired, update the source file, with the block, and create I/O place holders, or use actual names if the user defines the names within the data naming control fields or can even import a name list from a file or any other record. The tool views are presented in a configurable graphical window that can contain the widgets of interest (e.g., floorplan, power across die, early timing, etc.).

Intelligent tools are then presented to enable the user to modify the architecture. The embodiments herein include global scaling of blocks, based on technology scaling rules, replacement of blocks with best fit from target technology, and individual block modification, guided by the design planning tool. The user can search the cloud-based database for new blocks by name, and the design planning tool will suggest blocks based on connectivity and prior user design history (from the cloud-based database) on placement of a block with similar connectivity. For example, the embodiments herein can extract the block placement history from pipelined processor designs of a plurality of different users who have uses the cloud-based database in the past. The embodiments herein include rule-based suggestions, list views, and new block with user input, etc. As the user makes changes, the tool views are updated.

Therefore, in one specific exemplary implementation, one method herein maintains a database connected to a wide area network (WAN) such as a cloud-based network. This exemplary method maintains base processor or digital design descriptions and associated base instruction sets containing base instructions by extracting the base processor or digital design description and the base instructions from pipelined processor designs of a plurality of different users who use the cloud database. The method also maintains, in the database, configurable features having additional instructions different from the base instructions by extracting the configurable features and the additional instructions from the pipelined processor designs of the plurality of different users who use the cloud database.

The method then receives a configuration specification for the configurable pipelined processor. To facilitate this, this exemplary method can provide the icon-based graphic displays shown below of the base processor or digital design descriptions, the base instruction sets, the base instructions, the configurable features, and the additional instructions. The icon-based graphic display can be presented as a floorplan arrangement and the icon-based graphic display permits drag-and-drop placement actions and drag resizing options. The method therefore receives, through the icon-based graphic display, user selection of a base processor or digital design description from the base processor or digital design descriptions within the database, user selection of a base instruction set from the base instruction sets within the database, and user selection of at least one configurable feature from the configurable features within the database.

The method generates a hardware implementation for the configurable pipelined processor based on the configuration specification, using the computerized device, to produce a plurality of configured pipeline stages. The configured pipeline stages are different from base pipeline stages in a base processor or digital design hardware implementation corresponding to the base processor or digital design description as a result of at least one additional instruction associated with the configurable feature being included in the configuration specification. The method also generates, based on the configuration specification, a plurality of software development tools including an application program compiler using the computerized device. The application program compiler is used separately from the configuration specification.

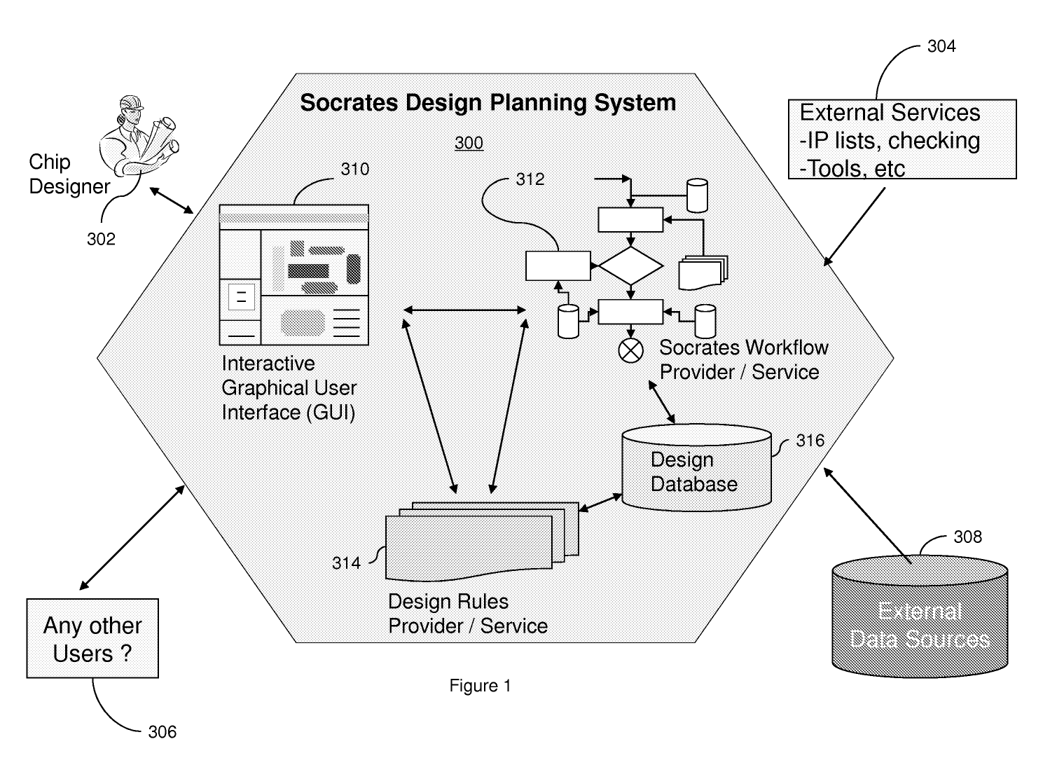

As shown in FIG. 1, an exemplary system 300 that helps guide the creation of an architecture in an intelligent manner links to existing die sizing engines, power estimation, floorplan and area estimation tools, etc. 312. This system has a graphical intuitive interface 310 that can interact with chip designers 302 and other users 306. The system has contact with external services (IP lists, checking tools, etc.) and external data sources 308 and external services 304 through a network, such as a cloud. The design database 316 is accessed by the design planning tool 312, as is the design rules and provider/services 314.

The embodiments provide a touch-based interactive graphic user interface 310, and provide intelligent import and adjustment of prior architecture 308, 314, 316, as well as provide an architectural engine with intelligence to aid the architect/user 302, 306 in the specification of the next block to place, based upon the existing blocks/architecture that has been defined. The rules based intelligence and statistical intelligence can be based on use history, for example of the current user or of many other users by extracting from other user's designs 304, 308 that are available through the cloud-based network. In the embodiments herein, learning is based not only on the individual, project, organization, or company, but also on worldwide user design base 304, 308 (e.g., internet, cloud, etc.).

With the embodiments herein, the multiple intelligence modes have a statistical basis from correlations of other user selections (within organization, or even from all worldwide users of the tool). For each block, the embodiments determine what parameters can be changed, are allowed to be changed, and allow new parameters to be added. The operations can be rules based, built into the tool, and also user defined 314. The resources can be search criteria based alphabetical, etc. Integration of the tools by embodiments herein enables efficient viewing of the sizing, impacts, etc., of selections, live.

Therefore, this system maintains base processor or digital design descriptions and associated base instruction sets containing base instructions by extracting the base processor or digital design description and the base instructions from pipelined processor designs of a plurality of different users who use a local area network (LAN) or a wide area network (WAN), such as the internet or cloud. This database 316 of previously established base processor or digital design can be extracted from, for example, the various data sources 304, 308, etc., that can be accessed through the cloud. The method also maintains, in the database 316 configurable features having additional instructions different from the base instructions by extracting the configurable features and the additional instructions from the pipelined processor designs of the plurality of different users who use the LAN, WAN, or cloud.

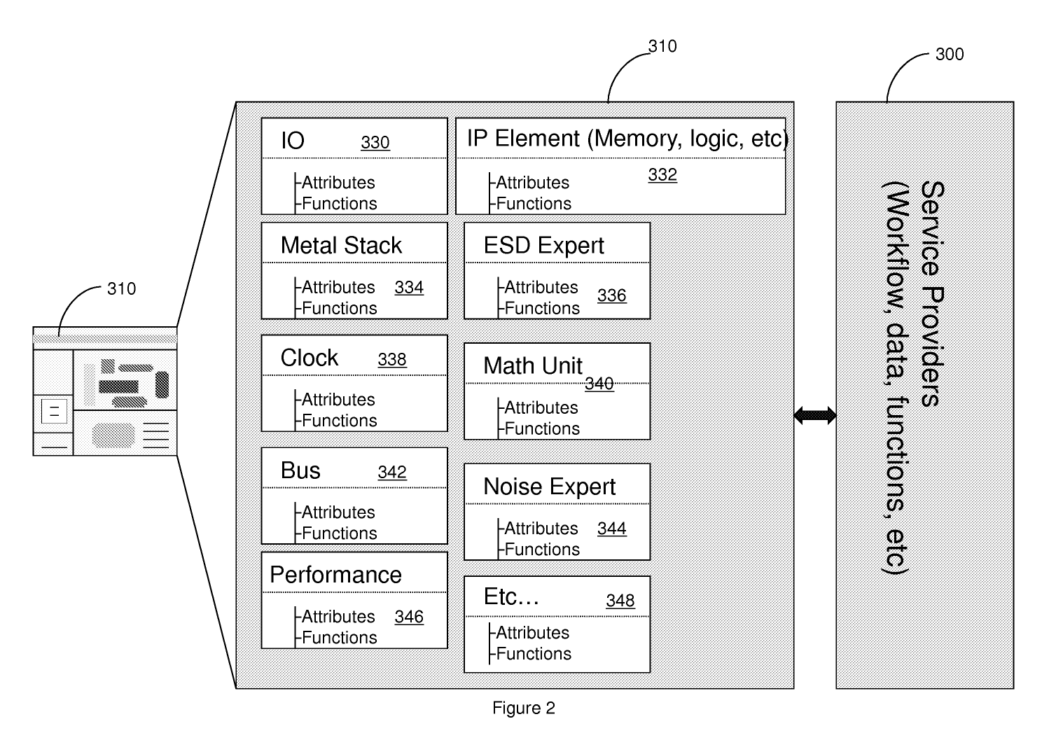

FIG. 2 illustrates the graphic user interface 310 in greater detail. The graphic user interface operatively connects to the system 300 of service providers (workflow, data, functions, etc.) shown in FIG. 1. In this specific, non-limiting example, FIG. 2 illustrates the following graphic features attributes and functions of; an I/O 330; IP element 332 (that includes memory, logic, etc); metal stack 334; ESD expert 336; clock 338; math unit 340; bus 342; noise expert 344; performance 346; and other features 348. FIG. 2 is only an example, and those ordinarily skilled in the art would understand that many other features could be included in the display 310.

An exemplary workflow interaction with the graphic user interface 310 could ask if the user has a pre-existing design. If so, the embodiments analyze the pre-existing design, placement and definition, macro's, I/O's, memory, etc. The embodiments can import the pre-existing design into the tools, enable intelligence for derivatives, and has the ability to add/delete existing blocks. The graphic user interface 310 could also ask how much does the user expect the die to grow, the die area, content, circuit count, and provide a percentage answer. The systems and methods herein stretch the floorplan automatically, and the methods can also delete blocks and identify or make changes. The graphic user interface 310 could also ask whether the user expects any of the existing blocks to scale up or down, and the systems and methods herein allow the user to change sizes with the intelligent user interface. The embodiments herein can know from prior generation migrations what the block changes will be and will make corresponding changes in the tool.

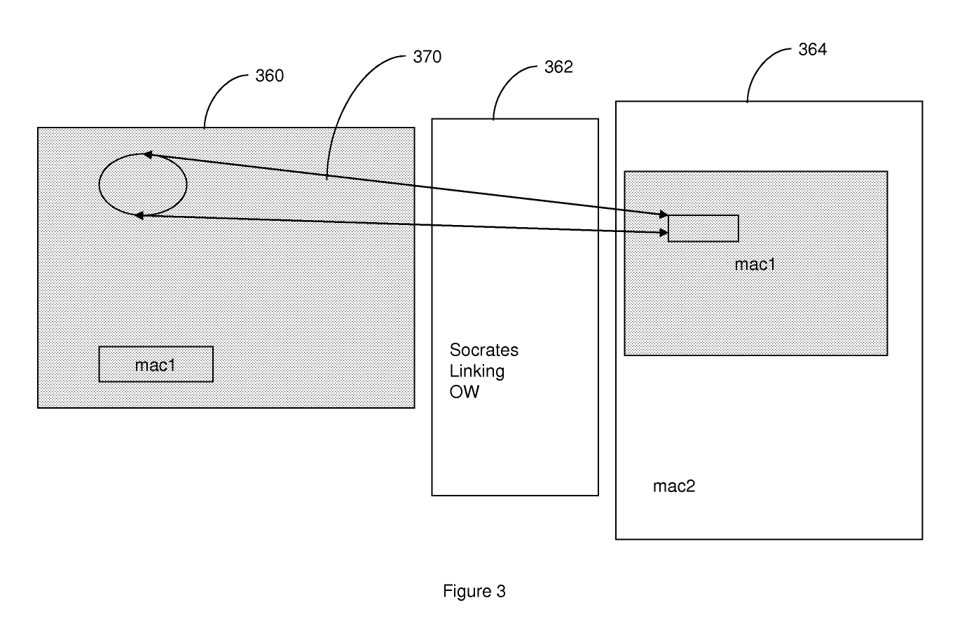

FIG. 3 illustrates a gate netlist/RTL netlist link. When adding blocks, the process starts with a picture of floorplan 360. Arrows 370 conceptually illustrate the user dragging new content from floorplan 364, using the system 300 shown in FIG. 1. Thus, item 370 can be through of working in a rubber band mode to move content around, and select a function for floorplan 360 (or vice versa for floorplan 364). The user can draw connections between blocks by dragging a finger in the user interface 310 between two blocks 360, 362, double tap/etc., to select parameters for connection based on connections, speed, type, parallel, serial, etc. FIG. 3 also illustrates the gate netlist/RTL netlist link 362, that contains the object world (OW) representation of the physical world of the RTL netlist of mac1 within mac2 and the future physical guess of incremental physical dimensions (PD) of the object world of (Mac2-Mac1). Thus, FIG. 3 illustrates reusing Mac1 in a new design Mac2 to understand incrementally what Mac2 will physically occupy.

While changes are being made, the tool updates other widget windows, such as: area congestion, power impacts, and early timing. The embodiments herein have the ability to adjust design speed, e.g., percentage of speed increase, and automatically adjust assertions for blocks based upon change to speed. If the user is inputting an existing netlist (which is useful to refresh the tool as the design execution progresses) the embodiments learn the statistics of connections between blocks, and add data into the database on usage. The embodiments illustrate a smart table approach and intuitive interface that includes touch interface, drag, drop, move around, resize, etc. The embodiments can change the CAD tool window contents and dock/undock widgets for different functions.

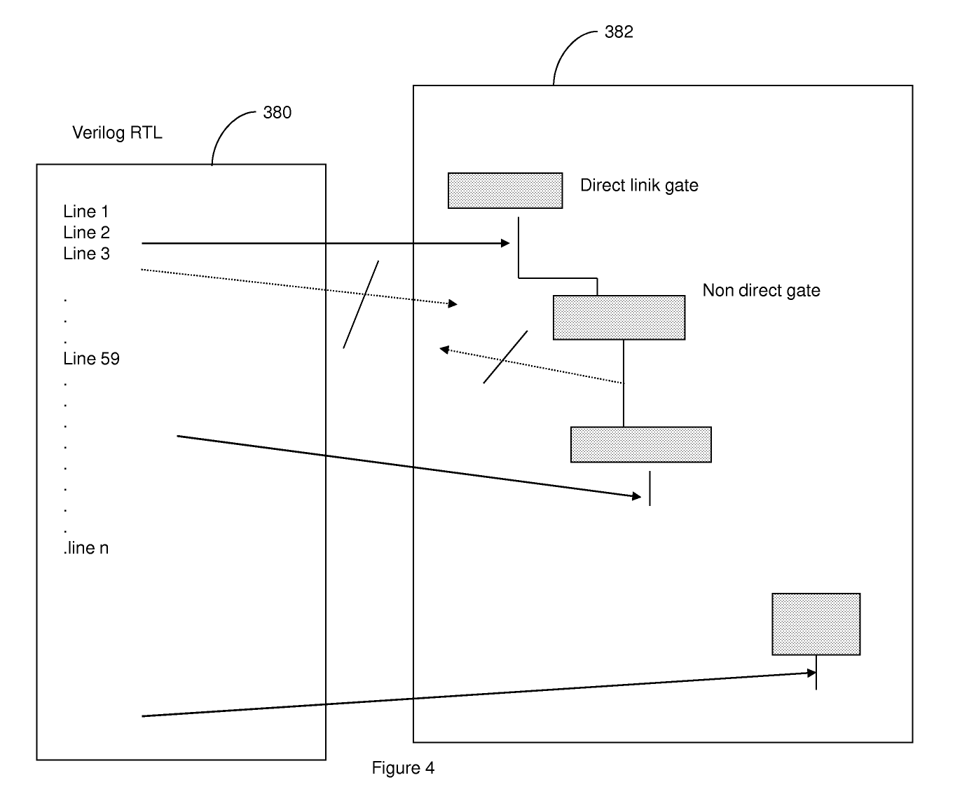

FIG. 4 illustrates a RTL to netlist floorplanner that includes a Verilog RTL code file 380, and an instantiated netlist floorplan 382 having items such as direct link gates, non-direct gates, etc. The user interface 310 displays control information, setup files, technology files, and library files. The graphical interface 310 for the user is designed like a visual floorplanner and includes real time links to the source files (shown by the arrows in FIG. 4). The graphical interface 310 for the user also builds tools as the function is added, and designs automation for updating netlists, etc.

The interpretation/building from the previous architecture is performed by reading in previous designs, reading in previous PD information, and technology scaling (if needed). The user interface includes feedback cycles for actual results, power/area/wiring constraints, and assumptions. The assumptions include vigorous naming conventions, for consistent block naming, netlist naming, etc, and an ID driven link tool—metadata structure—name and instance and version and enterprise class (EC).

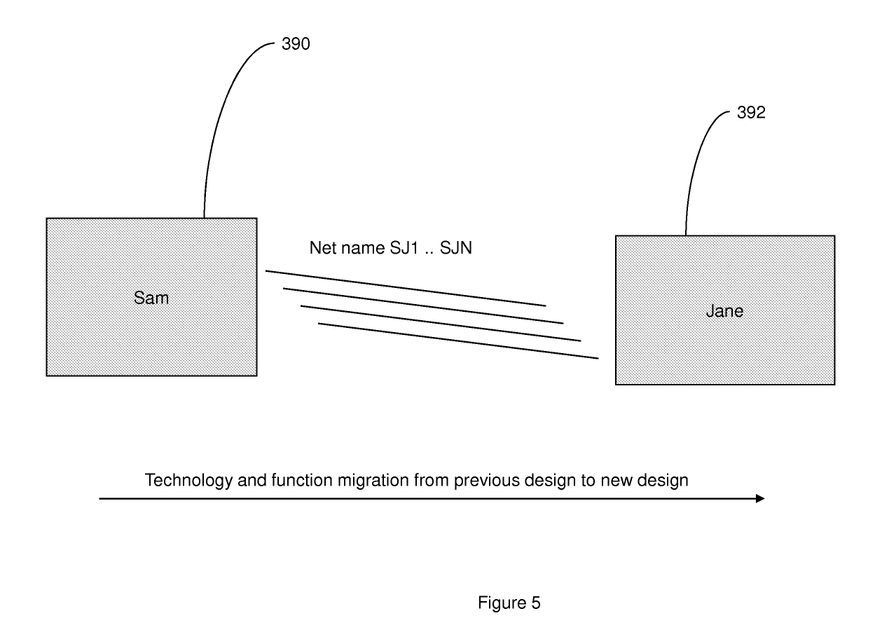

FIG. 5 illustrates an exemplary gate netlist migration. The embodiments herein import a new netlist 390, recognize that net names of updated Jane 392 follow the same naming convention, recognize the increase in the number of bits in the bus, and automatically update the connections from Sam 390 to Jane 392 by Y delta increase in the connections. The methods herein define the parameters of the files that the design planning system would be required to migrate to a new technology.

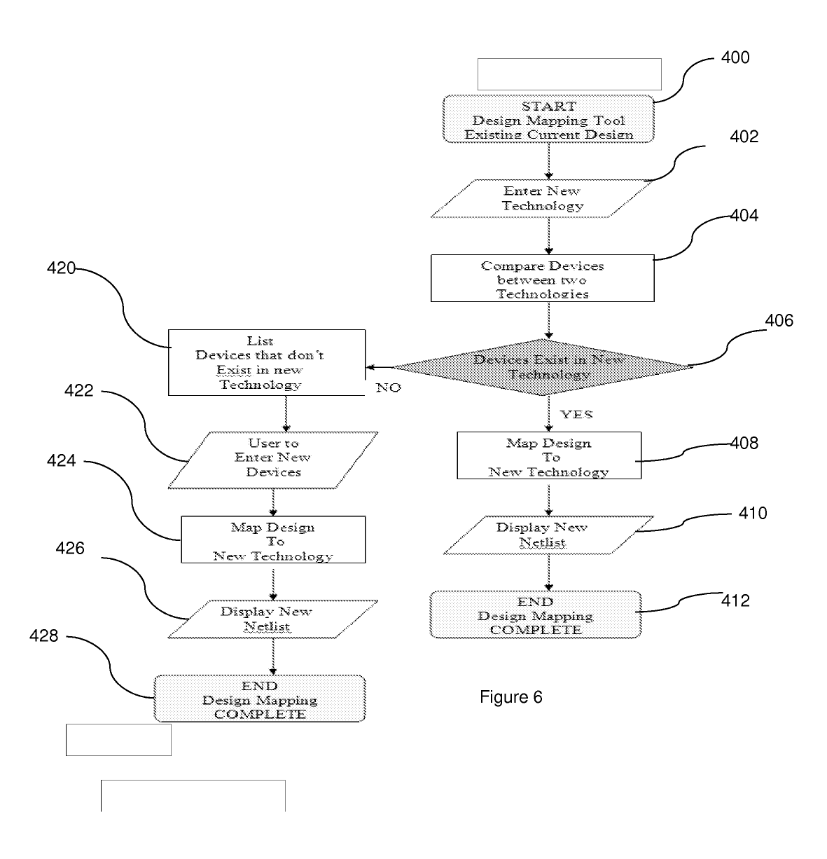

FIG. 6 is a flow diagram illustrating gate netlist migration. The flow diagram starts in item 400, by designing a mapping tool for the existing current design. In item 402, the user enters a new technology, and the method compares devices between the two technologies 404. In item 406, the method determines if devices exist in the new technology. If so, the method maps a design to the new technology 408, and displays a new netlist 410. The design mapping is complete in item 412. If no devices exist in the new technology 406, the method lists devices that do not exist in the new technology 420. Next, the user enters new devices in item 422, and the method then maps a design to the new technology 424. The display shows the new netlist 426, and completes design mapping in 428.

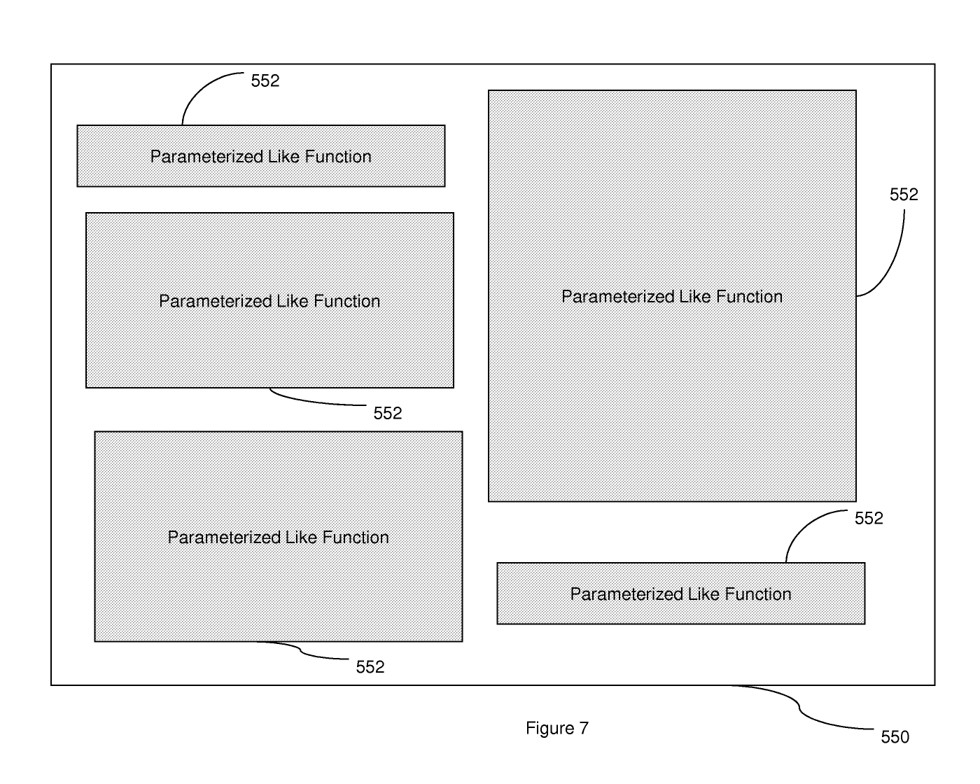

FIG. 7 illustrates one example of how the display 550 can show the parameterized functions 552 in the program to allow the user configuration flexibility. This can display the floorplan, hierarchy, calculation such as power/area, etc, and can be selected for each box 552. Pop ups, dialogue boxes, and selection lists, are brought forward when configuring existing or new blocks in the architecture. The design planning system can assign tasks such as: query the user, new block, new function, new connection, etc. This top down approach can start the architecture at a high level. The tailored artificial intelligence approach includes rules that are combined with usage patterns for continued learning, and has the ability to update and refine the process. The embodiments herein perform a comparison of final with predicted version control, and provide comparison modes. The learning method to improve questions includes a tool selection dialogue that will change based upon use. Further, dynamic selection dialogue is based upon learning of usage, e.g., it can hide functions not used, display other functions based on complexity of usage, etc.

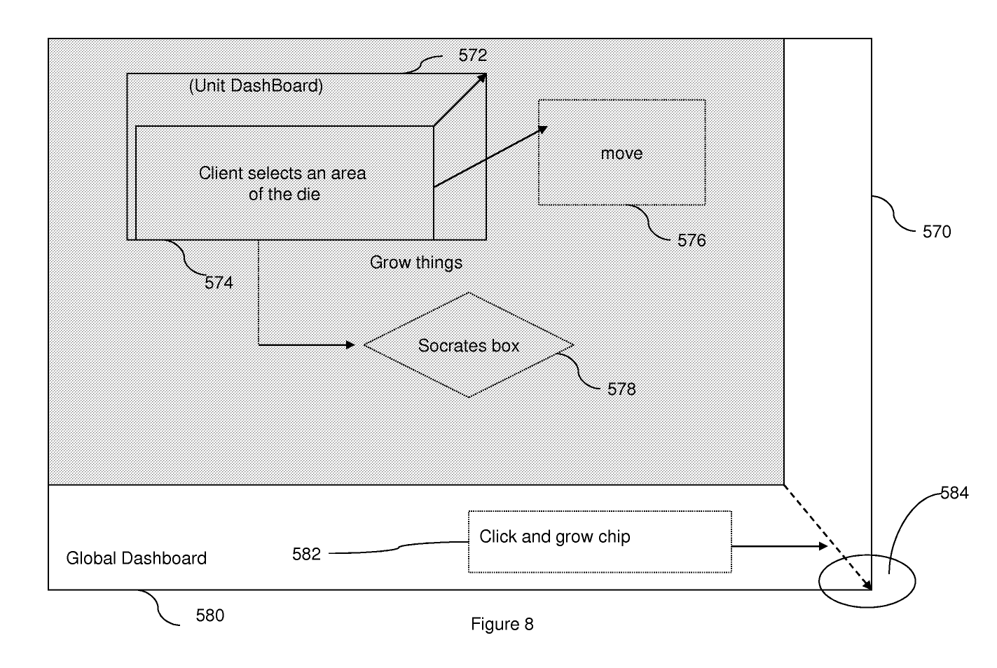

FIG. 8 illustrates how a dialog begins (written or voice recognition) in a diagram 570. The schematic diagram shows a unit dashboard 572, and how the clients select an area of the die 574, and then moves that area in item 576. An exemplary Socrates box is shown in item 578. FIG. 8 includes a global dashboard 580, and shows how a user can click and grow the chip 582 by moving a corner 584.

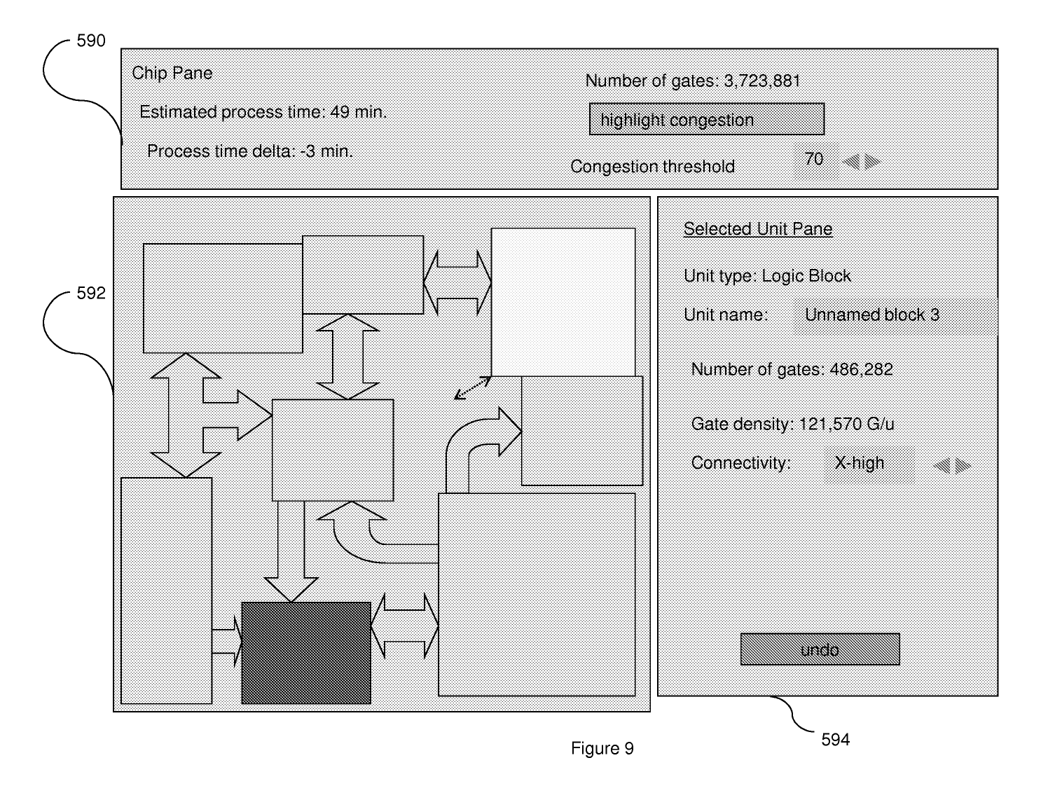

FIG. 9 illustrates a chip pane 590 that estimates the process time, process time delta, number of gates, and congestion threshold, and block 592 that includes various areas of the die that can be selected, moved, expanded, etc. by drag-and-drop operations, drag-resize operations through the touch-screen graphic user interface. The selected unit pane 594 displays the unit type, logic block, unit name, number of gates, gate density, connectivity, undo, etc. of the pane that is currently selected.

Therefore, as shown above, the method and systems herein receives a configuration specification for the configurable pipelined processor using at least one graphic user interface of the computerized device. To facilitate this, this exemplary method can provide an icon-based (or widget-based) graphic display (e.g., FIGS. 3-5 and 7-9) of the base processor or digital design descriptions, the base instruction sets, the base instructions, the configurable features, and the additional instructions. As shown above, the icon-based graphic display can be presented as a floorplan arrangement and the icon-based graphic display permits drag-and-drop placement actions and drag resizing options. The method therefore receives, through the icon-based graphic display, user selection of a base processor or digital design description from the base processor or digital design descriptions within the database 316, user selection of a base instruction set from the base instruction sets within the database 316, and user selection of at least one configurable feature from the configurable features within the database 316.

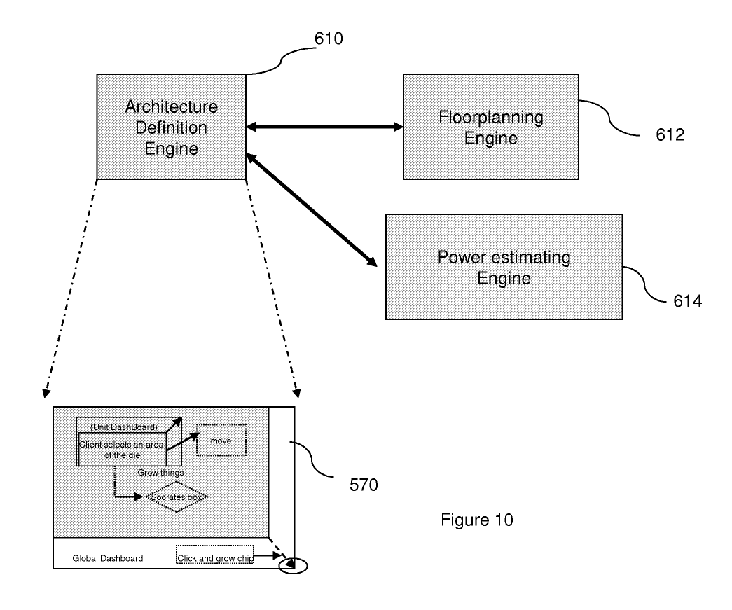

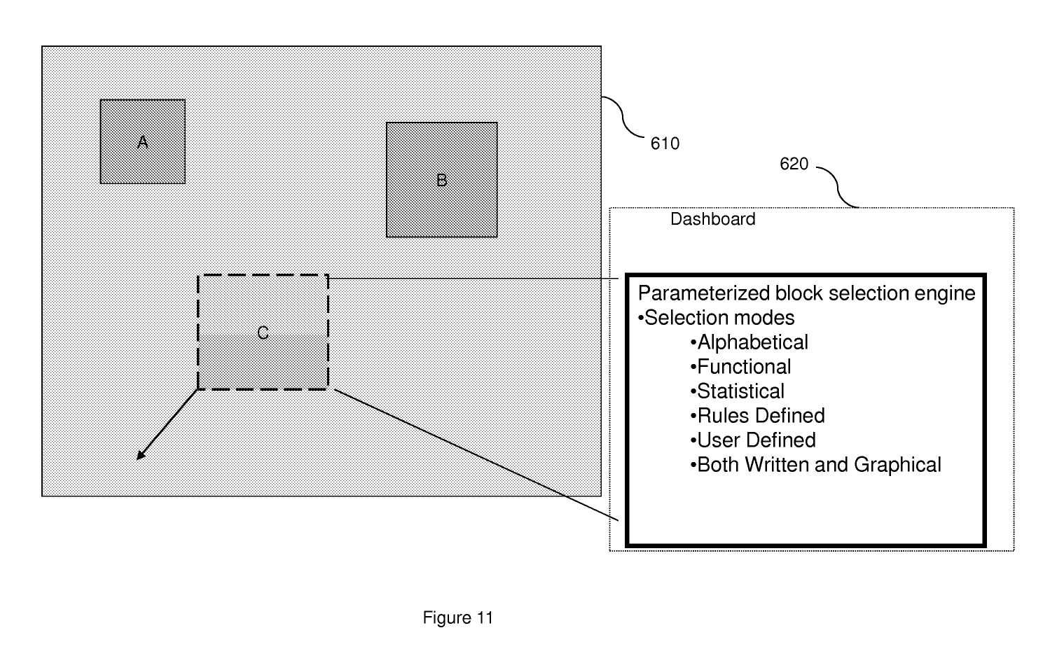

FIG. 10 shows one example of an exemplary program flow, where the architecture definition engine 610 can connect to the global dashboard 570 or connect to the floorplanning engine 612 or the power estimating engine 614. Further, the architecture definition engine 610 provides the display 570, discussed above. FIG. 11 shows the architecture creation engine 610 in greater detail. The dashboard 620 for item C in 610 includes a parameterized block selection engine and selection modes, which can be alphabetical, functional, statistical, rules defined, user defined, or both written and graphical. Each block is a multidimensional control point that allows the user to change the shape, size, speed, etc.

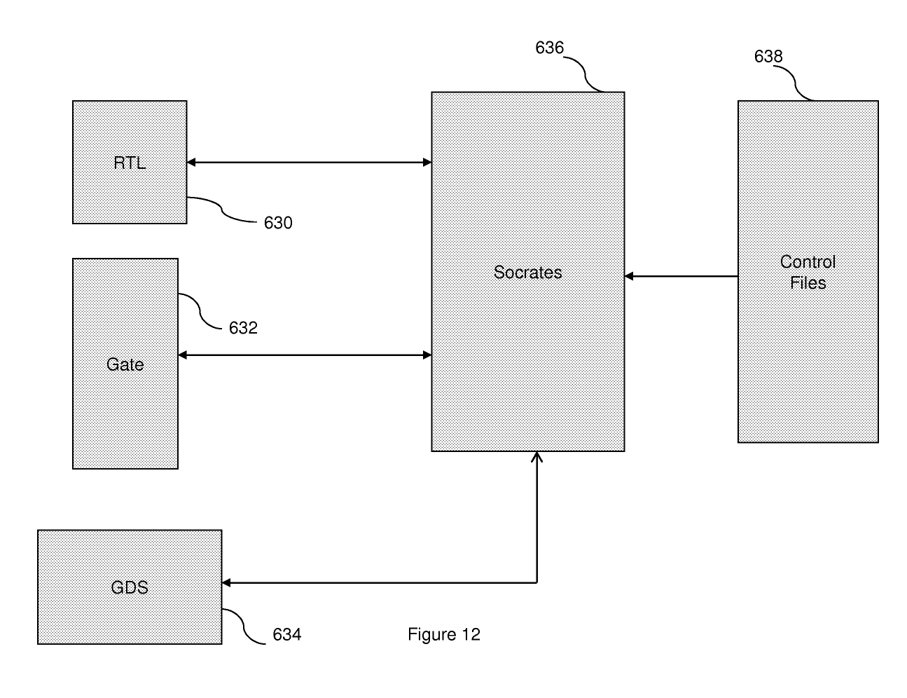

FIG. 12 illustrates one example of exporting/importing changes. As shown in FIG. 12, the RTL 630 is operatively connected to the design planning system (Socrates) 636 and to the control files 638. The gate 632 and GDS 634 are similarly operatively connected to the design planning system 636.

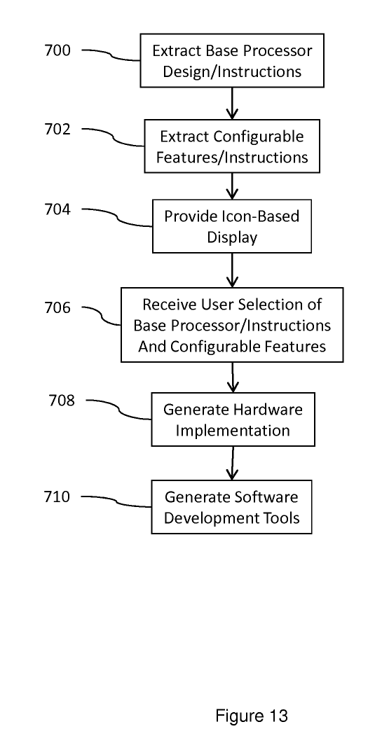

FIG. 13 is a flow diagram illustrating one exemplary implementation for designing a configurable pipelined processor. This exemplary method maintains a database connected to a wide area network (WAN) such as a cloud-based network. More specifically, this exemplary method maintains base processor or digital design descriptions and associated base instruction sets containing base instructions by extracting (in item 700) the base processor or digital design description and the base instructions from pipelined processor designs of a plurality of different users who use the cloud database. Item 700 also maintains, in the database, configurable features having additional instructions different from the base instructions by extracting (in item 702) the configurable features and the additional instructions from the pipelined processor designs of the plurality of different users who use the cloud database.

The method then receives a configuration specification for the configurable pipelined processor using at least one computerized device. To facilitate this, the exemplary method can provide an icon-based graphic display (in item 704) of the base processor or digital design descriptions, the base instruction sets, the base instructions, the configurable features, and the additional instructions. The icon-based graphic display can be presented as a floorplan arrangement and the icon-based graphic display permits drag-and-drop placement actions and drag resizing options. When the user exercises the drag-and-drop placement actions and drag resizing options, the computerized device automatically recalculates items such as integrated circuit (IC) size, power, leakage, performance, cost, etc.

The method therefore receives (in item 706) through the icon-based graphic display, user selection of a base processor or digital design description from the base processor or digital design descriptions within the database, user selection of a base instruction set from the base instruction sets within the database, and user selection of at least one configurable feature from the configurable features within the database.

Then, in item 708, the method generates a hardware implementation for the configurable pipelined processor based on the configuration specification, using the computerized device, to produce a plurality of configured pipeline stages. When generating the hardware implementation, the methods herein add logic to one of the base pipeline stages to produce the configured pipeline stages. Further, at least one of the configured pipeline stages is separate from any of the base pipeline stages. Each of the configured pipeline stages includes separate data and control paths. The configured pipeline stages are different from base pipeline stages in a base processor or digital design hardware implementation corresponding to the base processor or digital design description as a result of at least one additional instruction associated with the configurable feature being included in the configuration specification.

In item 710, the method also generates, based on the configuration specification, a plurality of software development tools including an application program compiler using the computerized device. The application program compiler is used separately from the configuration specification. When generating the software development tools the methods herein can generate a code assembly tool using the computerized device and can generate, as the application program compiler, a C compiler for C programming language (the C complier can compile all integer C programs for all available configuration specifications).

The methods and system herein therefore define library elements based on historical information extracted from previous designs (to maintain the database discussed above). Each block contains the information in the library necessary to feed the architecture engine, or feed the die sizing engine, etc. Information is defined such as I/O types, number, element type (memory/logic/analog), performance targets, type functions, width busses, how many busses, power requirements, and temperature range and maintained in the database. Also defined are unique floorplan arrangements, data flow directions, metal stacks, bus directions, clock domains, voltage domains, jitter tolerance, and RF circuits. Further defined are the ESD considerations, noise tolerance/high speed I/Os, sleep abilities, type of math units, branch structures, blocked out function, and how the user does the test.

Thus, this disclosure presents a user design system that controls the set of parameters of technology features. This set of parameters is for elements such as primitives, cells, and architecture blocks. With embodiments herein, a cloud of design data is established that can be queried for assistance. The methods and systems herein provide the ability to read and write user designs and the ability to convert to a dashboard representation of said design(s). Further, this disclosure provides a dynamic intelligent graphical human interface (DIGHI) control for alterations that allows real time altering of the design via the DIGHI and dashboard control methods. In addition, these systems and methods provide links back to the source file to update the design based upon the inputs changes; use rules based and history based directives for design change assists; link data structure between the RTL, gate netlist and GDSII file(s); and output data on each unit dashboard and full hierarchy support. Therefore, the embodiments herein provide a comprehensive linked design system between the user source RTL, gate netlist, GDSII that allows modification via the DIGHI. The methods and systems herein update both the source and destination, allow inputs from the previous design data including data from the cloud, and providing real time design trade-offs and results, with an integrated data management.

As will be appreciated by one skilled in the art, aspects of the embodiments herein may be embodied as a system, method or computer program product. Accordingly, aspects of the embodiments herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments herein may take the form of a computer program product embodied in at least one computer readable medium(s) having computer readable program code embodied thereon.

Any combination of at least one computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments herein may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments herein are described below with reference to flowchart illustrations and/or block diagrams of methods, apparatus (systems) and computer program products according to embodiments herein. It will be understood that each block of the flowchart illustrations and/or D-2 block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

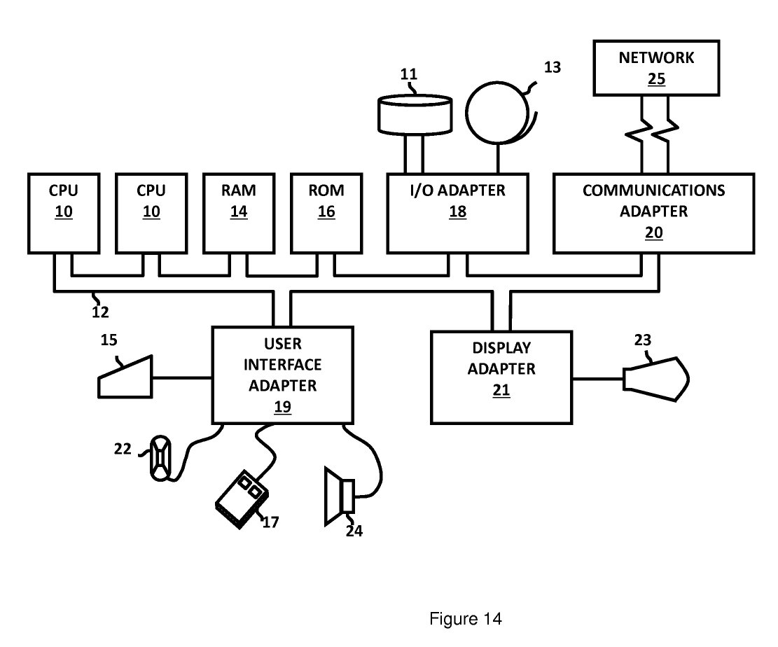

A representative hardware environment for practicing the embodiments herein is depicted in FIG. 14. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the figures illustrate the architecture, functionality, and operation of possible implementations of systems, methods and computer program products according to various embodiments herein. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Deployment types include loading directly in the client, server and proxy computers via loading a storage medium such as a CD, DVD, etc. The process software may also be automatically or semi-automatically deployed into a computer system by sending the process software to a central server or a group of central servers. The process software is then downloaded into the client computers that will execute the process software. The process software is sent directly to the client system via e-mail. The process software is then either detached to a directory or loaded into a directory by a button on the e-mail that executes a program that detaches the process software into a directory. The process software is sent directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

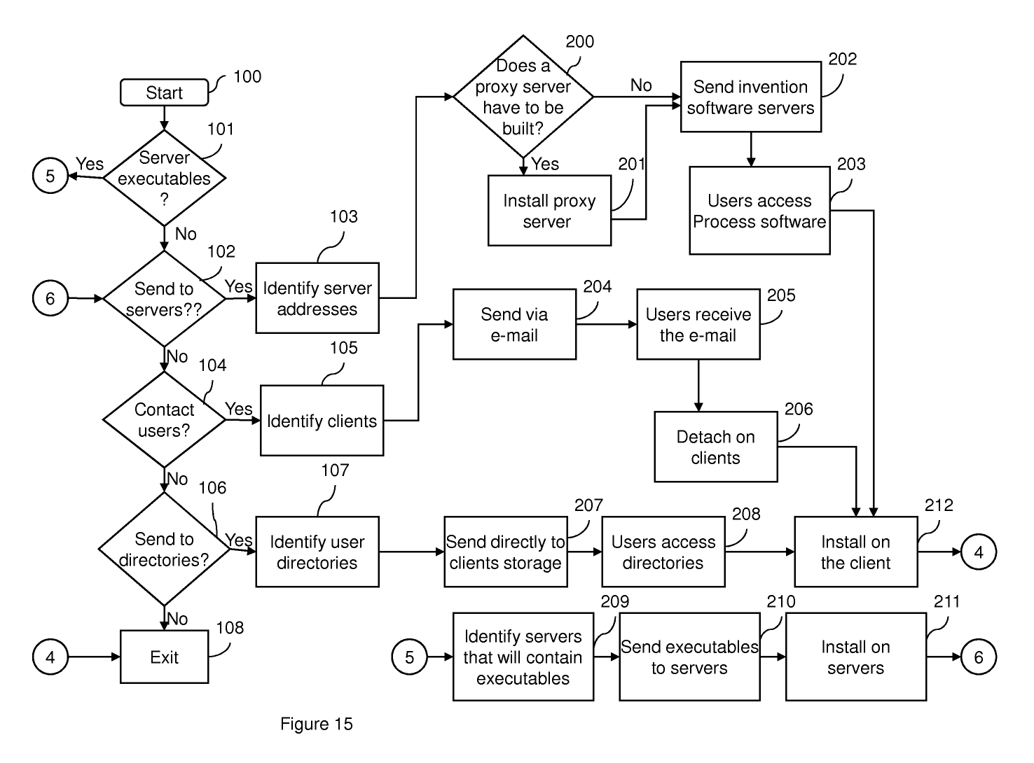

In FIG. 15, step 100 begins the deployment of the process software. The first thing is to determine if there are any programs that will reside on a server or servers when the process software is executed 101. If this is the case, then the servers that will contain the executables are identified 209. The process software for the server or servers is transferred directly to the servers' storage via FTP or some other protocol or by copying though the use of a shared file system 210. The process software is then installed on the servers 211. Next, a determination is made on whether the process software is be deployed by having users access the process software on a server or servers 102. If the users are to access the process software on servers, then the server addresses that will store the process software are identified 103.

A determination is made if a proxy server is to be built 200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 201. The process software is sent to the servers either via a protocol such as FTP or it is copied directly from the source files to the server files via file sharing 202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 203. Another embodiment is to have the servers automatically copy the process software to each client and then run the installation program for the process software at each client computer. The user executes the program that installs the process software on his client computer 212 then exits the process 108.

In step 104 a determination is made whether the process software is to be deployed by sending the process software to users via e-mail. The set of users where the process software will be deployed are identified together with the addresses of the user client computers 105. The process software is sent via e-mail to each of the users' client computers. The users receive the e-mail 205 and then detach the process software from the e-mail to a directory on their client computers 206. The user executes the program that installs the process software on his client computer 212, and then exits the process 108.

Lastly, a determination is made on whether to the process software will be sent directly to user directories on their client computers 106. If so, the user directories are identified 107. The process software is transferred directly to the user's client computer directory 207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 208. The user executes the program that installs the process software on his client computer 212 then exits the process 108.

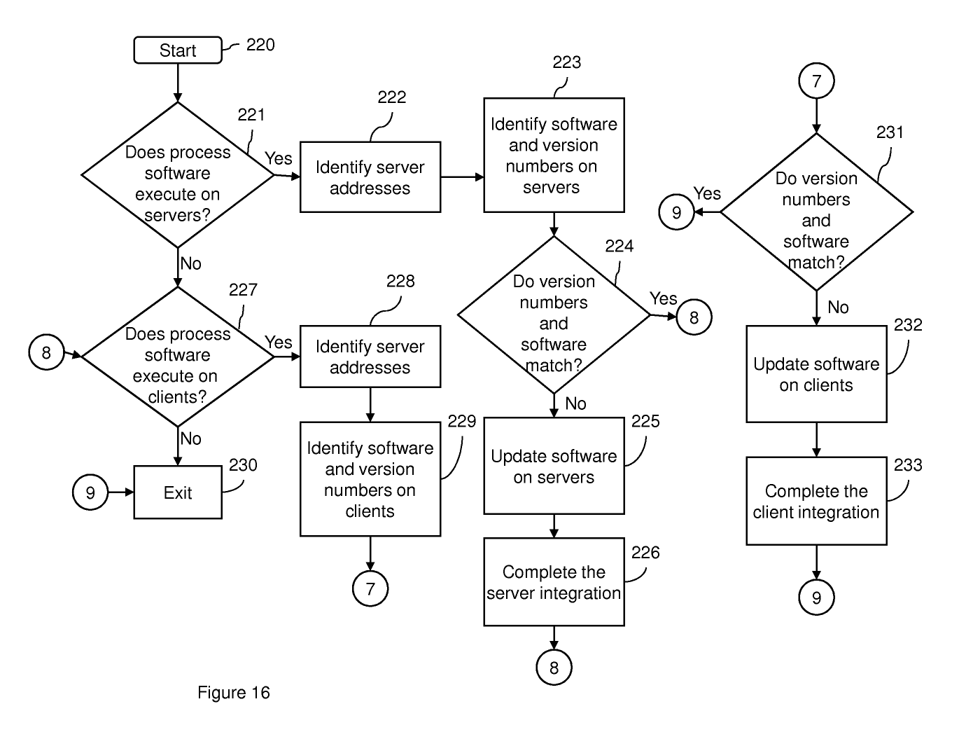

In FIG. 16, step 220 begins the integration of the process software. The first thing is to determine if there are any process software programs that will execute on a server or servers 221. If this is not the case, then integration proceeds to 227. If this is the case, then the server addresses are identified 222. The servers are checked to see if they contain software that includes the operating system (OS), applications, and network operating systems (NOS), together with their version numbers that have been tested with the process software 223. The servers are also checked to determine if there is any missing software that is required by the process software 223.

A determination is made if the version numbers match the version numbers of OS, applications and NOS that have been tested with the process software 224. If all of the versions match and there is no missing required software, the integration continues in 227.

If at least one of the version numbers do not match, then the unmatched versions are updated on the server or servers with the correct versions 225. Additionally, if there is missing required software, then it is updated on the server or servers 225. The server integration is completed by installing the process software 226.

Step 227 which follows either 221, 224 or 226 determines if there are any programs of the process software that will execute on the clients. If no process software programs execute on the clients, the integration proceeds to 230 and exits. If this not the case, then the client addresses are identified 228. The clients are checked to see if they contain software that includes the operating system (OS), applications, and network operating systems (NOS), together with their version numbers, that have been tested with the process software 229. The clients are also checked to determine if there is any missing software that is required by the process software 229.

A determination is made as to whether the version numbers match the version numbers of OS, applications and NOS that have been tested with the process software 231. If all of the versions match and there is no missing required software, then the integration proceeds to 230 and exits. If at least one of the version numbers do not match, then the unmatched versions are updated on the clients with the correct versions 232. In addition, if there is missing required software then it is updated on the clients 232. The client integration is completed by installing the process software on the clients 233. The integration proceeds to 230 and exits.

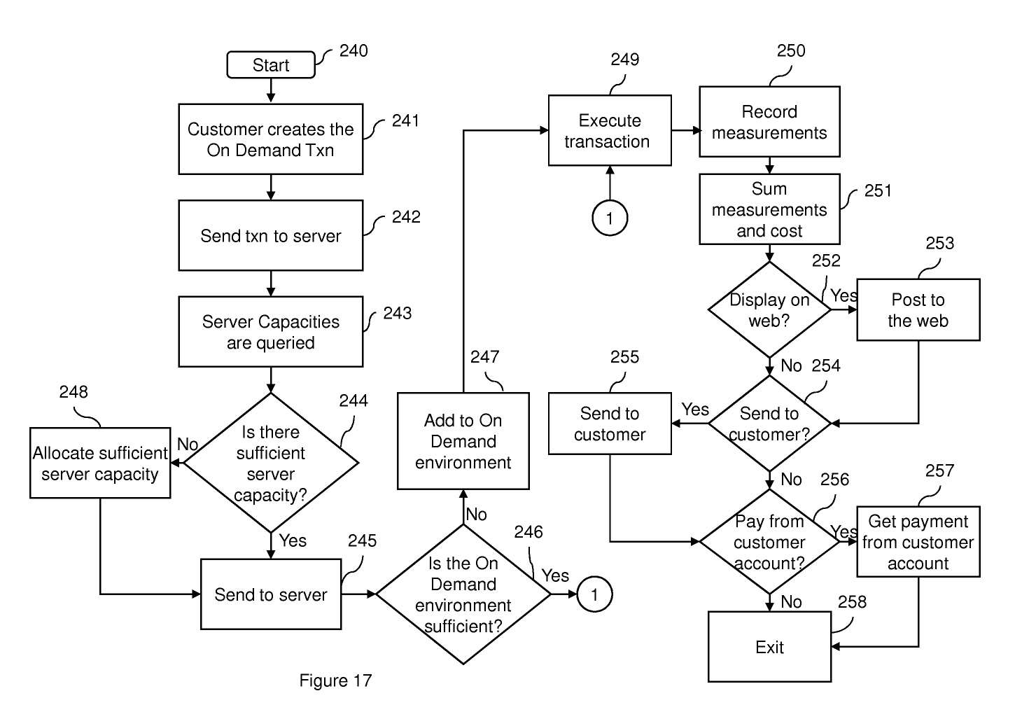

In FIG. 17, step 240 begins the On Demand process. A transaction is created that contains the unique customer identification, the requested service type and any service parameters that further specify the type of service 241. The transaction is then sent to the main server 242. In an On Demand environment, the main server can initially be the only server, then as capacity is consumed other servers are added to the On Demand environment.

The server central processing unit (CPU) capacities in the On Demand environment are queried 243. The CPU requirement of the transaction is estimated, then the servers available CPU capacity in the On Demand environment are compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next, the required software to process the transaction is accessed, loaded into memory, then the transaction is executed 249.

The usage measurements are recorded 250. The usage measurements consist of the portions of those functions in the On Demand environment that are used to process the transaction. The usage of such functions is, but not limited to, network bandwidth, processor memory, storage and CPU cycles are what is recorded. The usage measurements are summed, multiplied by unit costs and then recorded as a charge to the requesting customer 251. If the customer has requested that the On Demand costs be posted to a web site 252 then they are posted 253.

If the customer has requested that the On Demand costs be sent via e-mail to a customer address 254 then they are sent 255. If the customer has requested that the On Demand costs be paid directly from a customer account 256 then payment is received directly from the customer account 257. The last step is exit the On Demand process 258.

The process software may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

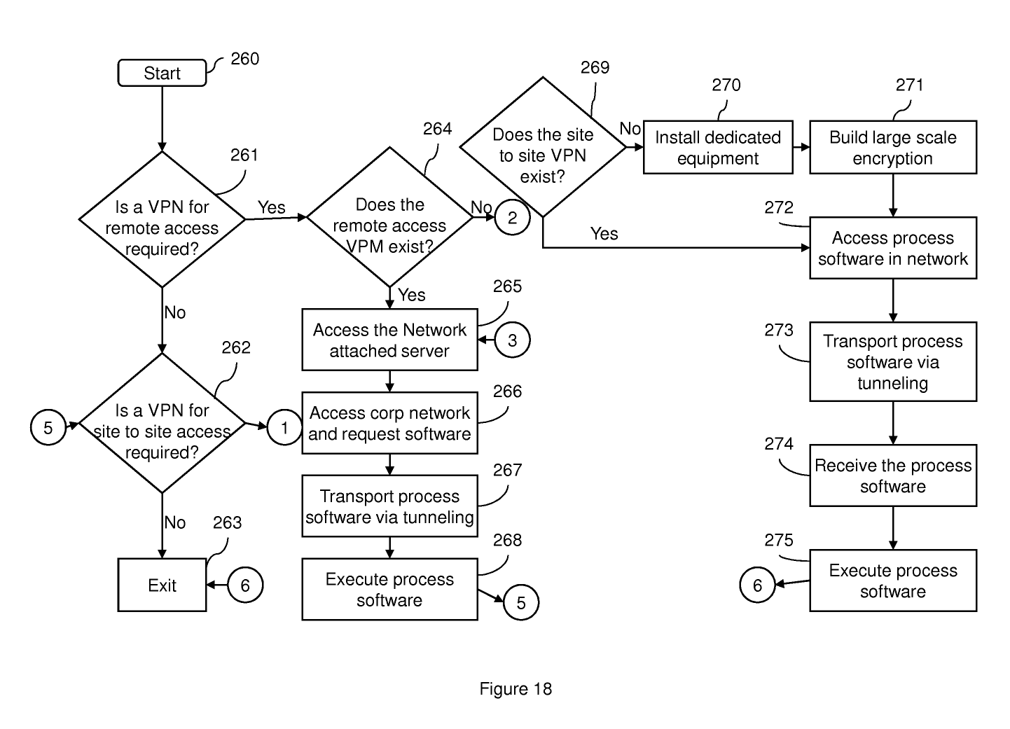

In FIG. 18, step 260 begins the Virtual Private Network (VPN) process. A determination is made to see if a VPN for remote access is required 261. If it is not required, then proceed to 262. If it is required, then determine if the remote access VPN exists 264. If it does exist, then proceed to 265. After the remote access VPN has been built or if it has been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling 273. That is, the process software is divided into packets and each packet including the data and protocol is placed within another packet 267. When the process software arrives at the remote user's desktop, it is removed from the packets, reconstituted and then is executed on the remote users desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then, build the large scale encryption into the VPN 271.

After the site to site VPN has been built or if it had been previously established, the users access the process software via the VPN 272. The process software is transported to the site users over the network via tunneling 273. That is, the process software is divided into packets and each packet including the data and protocol is placed within another packet 274. When the process software arrives at the remote user's desktop, it is removed from the packets, reconstituted and is executed on the site users desktop 275. Proceed to exit the process 263.

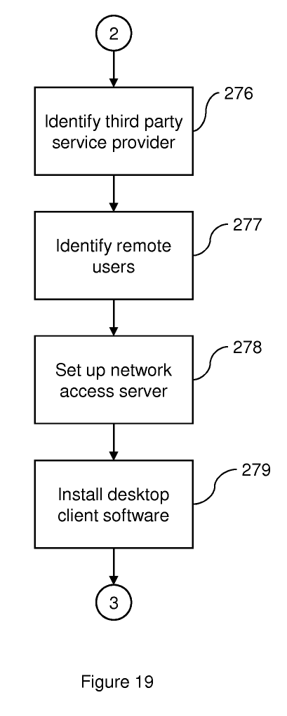

In FIG. 19, step 260 begins the Virtual Private Network (VPN) process. A determination is made to see if a VPN for remote access is required 261. If it is not required, then proceed to 262. If it is required, then determine if the remote access VPN exists 264. If it does exist, then proceed to 265. Otherwise, the embodiments identify the third party provider that will provide the secure, encrypted connections between the company's private network and the company's remote users 276. The company's remote users are identified 277. The third party provider then sets up a network access server (NAS) 278 that allows the remote users to dial a toll free number or attach directly via a cable or DSL modem to access, download and install the desktop client software for the remote-access VPN 279.

After the remote access VPN has been built or if it been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling. That is, the process software is divided into packets and each packet including the data and protocol is placed within another packet 267. When the process software arrives at the remote user's desktop, it is removed from the packets, reconstituted and then is executed on the remote user's desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then build the large scale encryption into the VPN 271. After the site to site VPN has been built or if it had been previously established, the users access the process software via the VPN 272. The process software is transported to the site users over the network via tunneling. That is, the process software is divided into packets and each packet including the data and protocol is placed within another packet 274. When the process software arrives at the remote user's desktop, it is removed from the packets, reconstituted and is executed on the site user's desktop 275. Proceed to exit the process 263.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments herein has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiment and the practical application, and to enable others of ordinary skill in the art to understand the embodiment for various embodiments with various modifications as are suited to the particular use contemplated.

What is claimed is:

1. A computer-implemented method for designing a processor, said method comprising:
maintaining, in a database connected to a wide area network (WAN), base processor or digital design descriptions and associated base instruction sets containing base instructions by extracting said base processor or digital design description and said base instructions from processor designs of a plurality of different users who use said WAN;
maintaining, in said database, configurable features having additional instructions different from said base instructions by extracting said configurable features and said additional instructions from said processor designs of said plurality of different users who use said WAN;
receiving a configuration specification for said processor using at least one computerized device, said receiving of said configuration specification comprising a user selecting a base processor or digital design description from said base processor or digital design descriptions within said database, selecting a base instruction set from said base instruction sets within said database, and selecting at least one configurable feature from said configurable features within said database;
generating a hardware implementation for said processor based on said configuration specification, using said computerized device, to produce a plurality of configured pipeline stages, said configured pipeline stages being different from base pipeline stages in a base processor or digital design hardware implementation corresponding to said base processor or digital design description as a result of at least one additional instruction associated with said configurable feature being included in said configuration specification; and
generating, based on said configuration specification, a plurality of software development tools including an application program compiler using said computerized device.

2. The method of claim 1, said providing of said configuration specification comprising selecting processor features using a graphical user interface of said computerized device.

3. The method of claim 1, said generating of said software development tools further comprising generating a code assembly tool using said computerized device.

4. The method of claim 1, said generating of said software development tools comprising generating, as said application program compiler, a C compiler for C programming language.

5. The method of claim 1, said generating of said software development tools comprising generating a C complier to compile all integer C programs for all available configuration specifications.

6. The method of claim 1, each of said configured pipeline stages including separate data and control paths.

7. The method of claim 1, said generating of said hardware implementation further comprising adding logic to one of said base pipeline stages to produce at least one of said configured pipeline stages.

8. The method of claim 1, at least one of said configured pipeline stages being separate from any of said base pipeline stages.

9. A computer-implemented method for designing a configurable pipelined processor, said method comprising:
maintaining, in a database connected to a wide area network (WAN), base processor or digital design descriptions and associated base instruction sets containing base instructions by extracting said base processor or digital design description and said base instructions from pipelined processor designs of a plurality of different users who use said WAN;
maintaining, in said database, configurable features having additional instructions different from said base instructions by extracting said configurable features and said additional instructions from said pipelined processor designs of said plurality of different users who use said WAN;
receiving a configuration specification for said configurable pipelined processor using at least one computerized device, said receiving of said configuration specification comprising:
providing an icon-based graphic display of said base processor or digital design descriptions, said base instruction sets, said base instructions, said configurable features, and said additional instructions, said icon-based graphic display being presented as a floorplan arrangement and said icon-based graphic display permitting drag-and-drop placement actions and drag resizing options, and
receiving, through said icon-based graphic display, user selection of a base processor or digital design description from said base processor or digital design descriptions within said database, user selection of a base instruction set from said base instruction sets within said database, and user selection of at least one configurable feature from said configurable features within said database;
generating a hardware implementation for said configurable pipelined processor based on said configuration specification, using said computerized device, to produce a plurality of configured pipeline stages, said configured pipeline stages being different from base pipeline stages in a base processor or digital design hardware implementation corresponding to said base processor or digital design description as a result of at least one additional instruction associated with said configurable feature being included in said configuration specification; and
generating, based on said configuration specification, a plurality of software development tools including an application program compiler using said computerized device, said application program compiler being used separately from said configuration specification.

10. The method of claim 9, when said user exercises said drag-and-drop placement actions and drag resizing options, said computerized device automatically recalculates at least one of integrated circuit (IC) size, power, leakage, performance, and cost.

11. The method of claim 9, said generating of said software development tools further comprising generating a code assembly tool using said computerized device.

12. The method of claim 9, said generating of said software development tools comprising generating, as said application program compiler, a C compiler for C programming language.

13. The method of claim 9, said generating of said software development tools comprising generating a C complier to compile all integer C programs for all available configuration specifications.

14. The method of claim 9, each of said configured pipeline stages including separate data and control paths.

15. The method of claim 9, said generating of said hardware implementation further comprising adding logic to one of said base pipeline stages to produce at least one of said configured pipeline stages.

16. A computerized system for designing a configurable pipelined processor comprising:
a database connected to a wide area network (WAN), said database maintaining base processor or digital design descriptions and associated base instruction sets containing base instructions by extracting said base processor or digital design description and said base instructions from pipelined processor designs of a plurality of different users who use said WAN, said database further maintaining configurable features having additional instructions different from said base instructions by extracting said configurable features and said additional instructions from said pipelined processor designs of said plurality of different users who use said WAN; and
at least one computerized device operatively connected to said database through said WAN, said computerized device receiving a configuration specification for said configurable pipelined processor, said receiving of said configuration specification comprising a user selecting a base processor or digital design description from said base processor or digital design descriptions within said database, selecting a base instruction set from said base instruction sets within said database, and selecting at least one configurable feature from said configurable features within said database,
said computerized device generating a hardware implementation for said configurable pipelined processor based on said configuration specification to produce a plurality of configured pipeline stages, said configured pipeline stages being different from base pipeline stages in a base processor or digital design hardware implementation corresponding to said base processor or digital design description as a result of at least one additional instruction associated with said configurable feature being included in said configuration specification, and
said computerized device generating, based on said configuration specification, a plurality of software development tools including an application program compiler, said application program compiler being used separately from said configuration specification.

17. The system of claim 16, said computerized device generating said software development tools by generating a code assembly tool using said computerized device.

18. The system of claim 16, said computerized device generating said software development tools by generating, as said application program compiler, a C compiler for C programming language.

19. The system of claim 16, said computerized device generating said software development tools by generating a C complier to compile all integer C programs for all available configuration specifications.

20. The system of claim 16, each of said configured pipeline stages including separate data and control paths.

21. The system of claim 16, said design planning system generating said hardware implementation by adding logic to one of said base pipeline stages to produce at least one of said configured pipeline stages.

22. A computer-readable storage device comprising a non-volatile computer-readable storage medium storing instructions executable by a computerized device, said instructions causing said computerized device to perform a method for designing a configurable pipelined processor, said method comprising:
maintaining, in a database connected to a wide area network (WAN), base processor or digital design descriptions and associated base instruction sets containing base instructions by extracting said base processor or digital design description and said base instructions from pipelined processor designs of a plurality of different users who use said WAN;
maintaining, in said database, configurable features having additional instructions different from said base instructions by extracting said configurable features and said additional instructions from said pipelined processor designs of said plurality of different users who use said WAN;
receiving a configuration specification for said configurable pipelined processor using at least one computerized device, said receiving of said configuration specification comprising a user selecting a base processor or digital design description from said base processor or digital design descriptions within said database, selecting a base instruction set from said base instruction sets within said database, and selecting at least one configurable feature from said configurable features within said database;
generating a hardware implementation for said configurable pipelined processor based on said configuration specification, using said computerized device, to produce a plurality of configured pipeline stages, said configured pipeline stages being different from base pipeline stages in a base processor or digital design hardware implementation corresponding to said base processor or digital design description as a result of at least one additional instruction associated with said configurable feature being included in said configuration specification; and
generating, based on said configuration specification, a plurality of software development tools including an application program compiler using said computerized device, said application program compiler being used separately from said configuration specification.

23. The computer-readable storage device of claim 22, said generating of said software development tools further comprising generating a code assembly tool using said computerized device.

24. The computer-readable storage device of claim 22, said generating of said software development tools comprising generating, as said application program compiler, a C compiler for C programming language.

25. The computer-readable storage device of claim 22, said generating of said software development tools comprising generating a C complier to compile all integer C programs for all available configuration specifications.
